(19) United States
(12) Patent Application Publication
(10) Pub. No.: US 2006/0083568 A1
(43) Pub. Date: Apr. 20, 2006

(54) Image forming apparatus

(75) Inventor: Shigeyuki Takahashi, Nagano-ken (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 11/180,916

(22) Filed: Jul. 14, 2005

(30) Foreign Application Priority Data
Jul. 15, 2004 (JP) 2004-208238

(51) Int. Cl. G03G 15/00

(52) U.S. Cl. 399/401

(57) ABSTRACT

An image forming apparatus which can conduct manual double-sided printing without mistaking the rear face of the paper for another paper, is provided. The image forming apparatus for executing manual double-sided printing in which paper is supplied by a user when printing on the rear face of the paper after printing on the front face of the paper is completed, has a display unit which displays a message reminding the user to issue an instruction to perform printing on the rear face after completing printing on the front face of the paper and discharging the paper, a control unit which issues a paper supply instruction according to the instruction from the user to perform printing on the rear face, and a printing unit which supplies paper from a prescribed paper supply unit according to the paper supply instruction and executing printing on the rear face.

### BACKGROUND OF THE INVENTION

1. Field of the Invention

The present invention relates to an image forming apparatus which can print on both sides of a sheet of paper, and more particularly to an image forming apparatus which can prevent printing of the rear face incorrectly on another sheet of paper, when manually double-sided printing.

2. Description of the Related Art

Conventionally, printing on both sides of the paper is used, for example, to save paper and the like, in image forming apparatuses such as printers and copiers and the like. Automatic double-sided printing in which the image forming apparatus handles the paper automatically, or manual double-sided printing in which, after printing on one face of the paper is complete, the paper is manually placed in the image formation apparatus again, are available for double-sided printing. With automatic double-sided printing, the paper must be mechanically inverted, and a mechanism for this purpose is provided. Furthermore, since the distance over which the paper is transported is increased, a mechanism to correct for oblique movement of the paper is also required. Therefore, while there is the advantage that inconvenient human intervention is not required, there are the disadvantages that the size of the apparatus increases, and the mechanism becomes increasingly complex and expensive. On the other hand, with manual double-sided printing, the afore-mentioned special mechanism is unnecessary, however, naturally, human intervention is required during printing, and there is the inconvenience to the user that caution and the like is required to ensure that the paper is inserted in the correct direction.

Therefore, various proposals have been made for the improvement of this manual double-sided printing. For example, in Japanese Patent Application Laid-open No. 2000-289259, a technology is disclosed in which a distinguishing mark recorded on the paper is detected to determine orientation of the paper during double-sided printing, and the orientation of the image is adjusted appropriately and double-sided printing is executed.

Furthermore, in some conventional apparatuses, to ensure that the user does not forget to set the paper in place when printing on the rear face as required with manual double-sided printing, printing on the rear face begins when an instruction from the user to execute printing on the rear face of the paper is received, and a message reminding the user to issue this instruction is displayed on the display panel and the like of the image forming apparatus during printing on the front face of the paper. Furthermore, a conventional technology also exists in which, after reminding the user to set the paper in place when printing on the rear face, placement of the paper is detected automatically and printing on the rear face of the paper begins without an instruction from the user.

However, with the system in which the user is reminded to issue an instruction for printing on the rear face of the paper during printing on the front face of the paper, the user may inadvertently issue the print instruction in a reflex action in some cases when this message is displayed. In this case, if another sheet of paper is placed in the tray supplying the paper on which the rear face is to be printed, the rear face will be printed by mistake on that sheet of paper immediately after printing on the front face is completed. Therefore, with this system, printing by mistake on another sheet of paper readily occurs.

Furthermore, even in the method in which the paper is detected automatically when printing on the rear face, in cases such as when the image forming apparatus is used by a plurality of users, with another user placing other paper in the paper supply tray, there is the possibility that the rear face of the paper will be printed on another sheet of paper. With this method in which there is no final instruction from the user, as well, printing by mistake on another sheet of paper may occur.

### SUMMARY OF THE INVENTION

Therefore, an object of the present invention is to provide an image forming apparatus which can print without printing the rear face on another sheet of paper by mistake when manually double-sided printing.

To achieve the afore-mentioned object, in one aspect of the present invention, the image forming apparatus for executing manual double-sided printing in which paper is supplied by a user when printing on the rear face of paper after printing on the front face of the paper is completed, has a display unit which displays a message reminding the user to issue an instruction to perform printing on the rear face after completing printing on the front face of the paper and discharging the paper, a control unit which issues a paper supply instruction according to the instruction from the user to perform printing on the rear face, and a printing unit which supplies paper from a prescribed paper supply unit according to the paper supply instruction and executing printing on the rear face. According to the present invention, therefore, when the user issues an instruction to perform printing on the rear face, since the sheet of paper to be used for which the face (front face) has already been printed is discharged, the instruction to perform printing on the rear face after the correct sheet of paper is placed in the prescribed paper supply unit is reliably issued, and printing of the rear face on another sheet of paper by mistake can be prevented.

Furthermore, in one mode of the present invention, the display unit displays a message to remind the user to set the paper in the paper supply unit when displaying the message to remind the user to issue the instruction to perform printing on the rear face. Thus, printing of the rear face on another sheet of paper by mistake can be further prevented when double-sided printing manually.

Further objects and features of the present invention will become clear from the embodiments of the present invention described below.

### BRIEF DESCRIPTION OF THE DRAWINGS

FIG. 1 shows the configuration according to an embodiment of an image forming apparatus using the present invention;

FIG. 2 shows an example of the configuration of the operation unit 7;

FIG. 3 is a flowchart showing an example of the details of processing conducted by the CPU 52 during post-processing;

FIG. 4 shows an example of messages displayed on the operation unit 7; and

FIG. 5 shows an example of a message displayed at the host computer 1.

### DESCRIPTION OF THE PREFERRED EMBODIMENTS

The embodiments of the present invention are described in reference to the figures, however the embodiments do not limit the technical scope of the present invention. In the description, the same reference numbers or reference symbols are applied to the same or similar components in the figures.

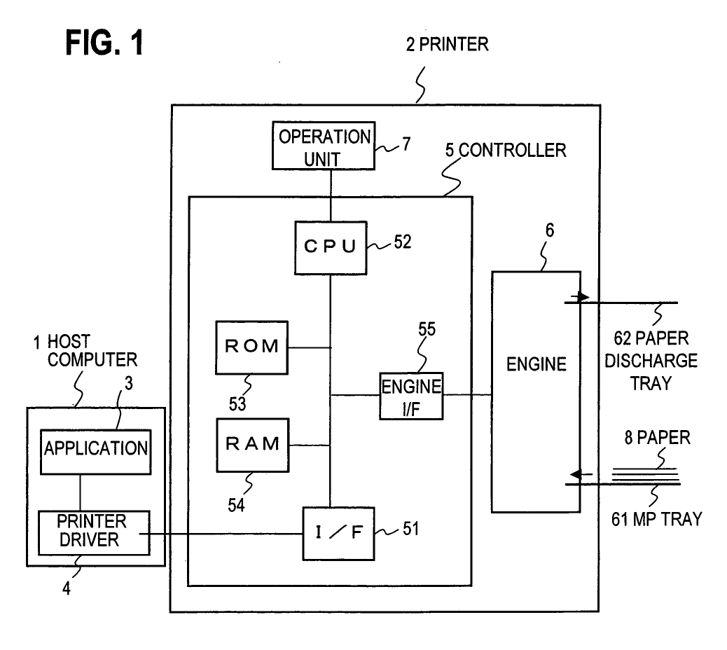

FIG. 1 shows the configuration of an embodiment of a printer being an image forming apparatus using the present invention. The printer 2 shown in FIG. 1 is an image forming apparatus using the present invention, and is an apparatus forming an image on the prescribed print media (paper 8) based on print requests and the like from a host computer 1. When manually double-sided printing, the printer 2 reminds the user to set the rear face of the sheet of paper in place, and to issue an instruction to perform printing on the rear face, at the appropriate time, and reliably conducts the correct double-sided printing without printing by mistake on another sheet of paper.

The host computer 1 shown in FIG. 1 is a host apparatus issuing print requests to the printer 2, and sending print data to be printed to the printer 2 based on user operation and the like. The host computer 1 can be comprised of an apparatus commonly referred to as a personal computer and the like. The application 3 in the host computer 1 is the source of print requests to the printer 2, and the user issuing print requests sets various conditions at printing via the interface provided by the application 3. Therefore, when the user desires manual double-sided printing, a request to this effect is also issued from the application 3.

Furthermore, the printer driver 4 receives data from the application 3 and generates the print data to be sent to the printer 2. The print data includes the actual image data to be printed, and control commands showing the various conditions and the like at printing. With manual double-sided printing, the number of pages manually double-sided printed in the requested print job is included in the print data, and the image data for the images on the front and rear faces is sent to from the printer driver 4 to the printer 2 in the prescribed order appropriate for manual double-sided printing.

For example, when manually double-sided printing of four pages, the image data is sent in the order of fourth page, second page, first page, and third page. On the other hand, at the printer 2, the fourth page and second page are printed on the front face of each of the two sheets of paper 8, and the first page and third page are then printed on the rear face of each of these two sheets of paper 8. Print processing for faces printed first (printing of the fourth and second pages in this example) during double-sided printing is referred to as ‘first-pass printing’, and print processing for faces printed later (printing of the first and third pages in this example) during double-sided printing is referred to as ‘second-pass printing’.

Furthermore, this printer driver 4 conducts processing to convert image data represented in PDL for each object to image data represented in density values of each pixel, processing to convert color representations of converted image data to color representations when printed by the printer 2, and processing to compress the converted data, and the like. In other words, a ‘host-based’ system is assumed in the present embodiment. The printer driver 4 is a program which causes the host computer 1 to execute processing related to the afore-mentioned functions. These functions are accomplished by the control device (not shown in figures) of the host computer 1 executing processing in accordance with the program.

The printer 2 receives print data sent from the host computer 1, and is a laser printer referred to as a ‘four-cycle laser printer’ in which printing is executed by the page. As shown in FIG. 1, the printer 2 has a controller 5, an engine 6, and an operation unit 7. The controller 5 has an I/F 51, a CPU 52, a ROM 53, a RAM 54, and an engine I/F 55.

The I/F 51 receives the print data sent from the host computer 1, and the ROM 53 stores various programs for controlling the printer 2. The RAM 54 is a memory storing the received print data and the like. Image data for each page processed by the engine 6 is passed from the RAM 54 to the engine I/F 55.

The CPU 52 controls the various processing conducted in the printer 2, and in particular, controls processing for storing image data included in the received print data in the RAM 54, processing to interpret control commands included in the print data and issue instructions to the engine 6 for the appropriate print processing, and processing to control the operation unit 7 forming the interface with the user. The printer 2 features these processing details when a manual double-sided printing request is received from the host computer 1. Practical details are described below. Processing executed by the CPU 52 is conducted primarily in accordance with the program stored in the ROM 53.

Next, the engine I/F 55 is the interface between the controller 5 and engine 6 which reads pixel data stored in the RAM 54 at the prescribed time when printing is executed with the engine 6, conducts the prescribed processing of the pixel data, and passes the processed pixel data to the engine 6. The engine I/F 55 has a memory for temporarily storing data, an uncompression unit, and a screen processing unit and the like (not shown in figures), and uncompresses the compressed pixel data read from the RAM 54, and conducts screen processing to convert that pixel data to dot data. Furthermore, in practice, the engine I/F 55 is comprised of an ASIC.

As shown in FIG. 1, the components of the controller 5 are mutually connected for sending and receiving of data.

Next, the engine 6 executes print processing based on data output from the engine I/F 55, and forms an image on a print media such as the paper 8 and the like. As with a normal laser printer, the engine 6 has a charging unit, and exposure unit, a developing unit, and a transfer unit and the like (not shown in figures). In the final stage of the print processing, the image is transferred from the transfer unit to the paper 8 supplied from the MP tray 61 being the paper supply tray, the image is fixed with a fixing unit (not shown in figures), and the paper 8 is then discharged to the paper discharge tray 62 after fixing. The basic configuration of the printer 2 has only the MP tray 61 as the paper supply tray, however other paper supply trays may be added.

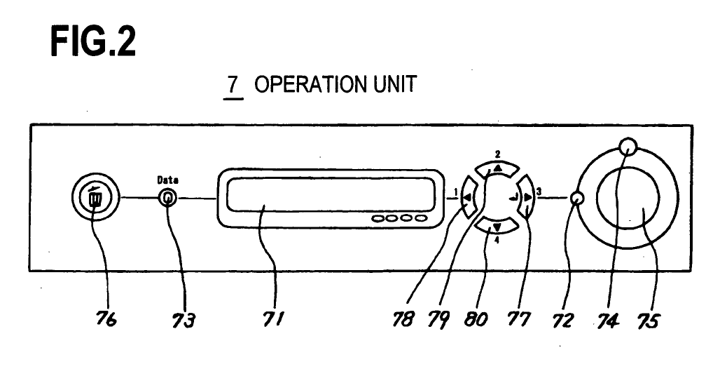

Furthermore, the operation unit 7 is used by the user to operate the printer 2, and is comprised of a display panel 71 and various operating buttons and the like. Entry of various settings such as print conditions in the printer 2 is possible with this operation unit 7, together with display of messages and issuing of instructions to execute printing when manually double-sided printing. FIG. 2 shows an example of the configuration of the operation unit 7. As shown in FIG. 2, the operation unit 7 has a display panel 71 being a liquid crystal display, switches 77 through 80 for entering various settings, various lamps 72 through 74 for notification of errors and the like, a print enable switch 75 instructing execution of print processing, and a cancel switch 76 for canceling print jobs.

Operation of the printer 2 according to the present embodiment having the configuration described above is described below. Since the printer 2 features manual double-sided printing processing as described above, the details of processing when manually double-sided printing are described. Firstly, when a print request for manual double-sided printing is issued from the host computer 1, the print data according to the print request is received by the I/F 51. Control commands included in the received print data are sent to the CPU 52 and interpreted, and various print conditions and the like for the print job are determined. At this time, the number of pages to be manually double-sided printed in the print job included in the print data is ascertained, and based on the fact that this number is not zero, the CPU 52 evaluates the print job as manual double-sided printing, and conducts control for manual double-sided printing (described below) at print processing in the engine 6. Furthermore, image data for each page included in the received print data is stored sequentially in the RAM 54, and retained in the RAM 54 until the prescribed time for beginning print processing in the engine 6.

For example, when a request for manually double-sided printing of four pages is received from the host computer 1, since information that the number of pages to be manually double-sided printed in the print job is four is included in the received print data, the CPU 52 evaluates that the current printing is manual double-sided printing, and since image data of four pages are sent in an order appropriate for manual double-sided printing, the image data is stored sequentially in the RAM 54 in that order. For example, as described above, the image data is stored in the order of fourth page, second page, first page, and third page.

Thus, pre-processing in the printer 2, in other words, processing in which print data is received and stored, is conducted, however, during or after this pre-processing, post-processing in the printer 2, in other words, print processing for the paper 8 based on received data, is conducted. The post-processing is begun at the prescribed time in accordance with the reception status of the image data and the status of the engine 6 and the like and conducted by the page. The primary feature of the printer 2 is in the content processed by the CPU 52 in this post-processing, and the practical details are described below.

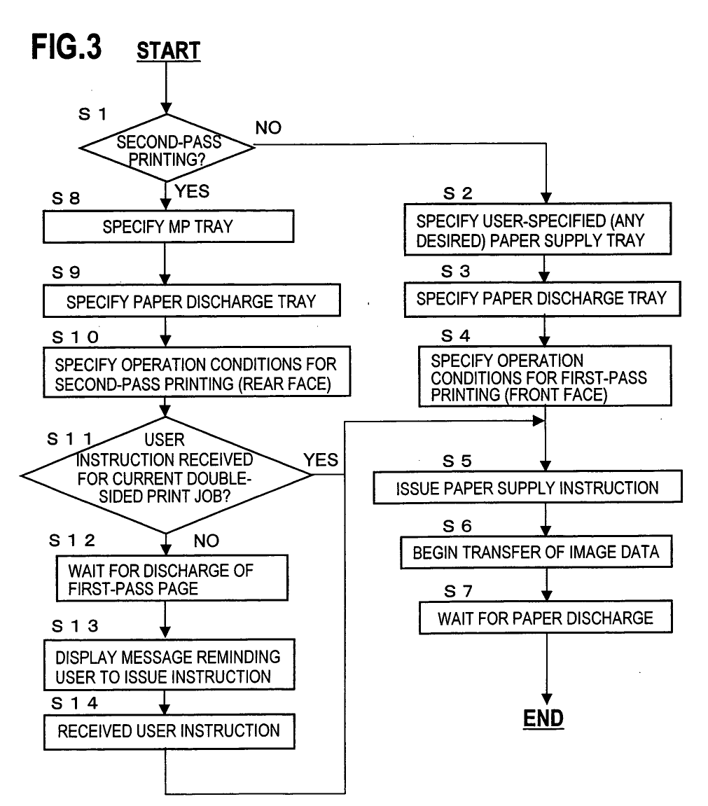

FIG. 3 is a flowchart showing an example of the details of processing for one page conducted by the CPU 52 during post-processing. Firstly, when the time at which print processing may begin is reached, the CPU 52 evaluates whether or not the relevant page of the pages to be printed in the received manual double-sided printing print job is in the second-pass printing of the manual double-sided printing (step S1). The evaluation is conducted according to preset rules based on information such as the order in which the page was processed in the requested print job, and information on the original order of the page.

If, as a result of this evaluation, the relevant page is not in the second-pass printing of the manual double-sided printing (NO in step S1), in other words, in the first-pass printing, the CPU 52 specifies the paper supply tray for the engine 6 (step S2). As described above, when the MP tray 61 is the only paper supply tray, the MP tray 61 is specified, however when a plurality of paper supply trays is used, any tray, for example, a tray specified by the user, can be specified. The CPU 52 then specifies the paper discharge tray for the engine 6 (step S3). The paper discharge tray 62 is specified here.

Next, the CPU 52 specifies the operating conditions for the first-pass printing for the engine 6 (step S4). Operating conditions mean the various conditions such as transfer voltage and the like during print processing. In the first-pass printing, the same operating conditions as with single-sided printing are normally specified. The CPU 52 then instructs the engine 6 to supply paper (step S5), and begins transfer of the image data for the relevant page to the engine 6 (step S6). In practice, the image data stored in the RAM 54 is read sequentially, subjected to the prescribed processing with the engine I/F 55, and passed to the engine 6.

At the engine 6 side, print processing for the supplied paper 8 is executed based on the transferred image data. The CPU 52 waits for completion of the print processing and discharge of the paper 8 after printing (step S7). Thus, processing by the CPU 52 for the relevant page is completed.

When a request for manual double-sided printing of four pages is received, processing is conducted for each of the fourth page and second page in the first-pass printing according to the content of the steps S2 through S7 described above.

On the other hand, when the second-pass printing is determined in step S1 (YES in step S1), processing moves to step S8, and the CPU 52 specifies the MP tray 61 as the paper supply tray, and the paper discharge tray 62, for the engine 6 (step S8 and step S9). In the example of manual double-sided printing of four pages, second-pass processing is conducted for the first and third pages. Even when a plurality of paper supply trays are provided, paper supply tray for the second-pass printing is fixed as the MP tray 61.

Next, the CPU 52 specifies the operating conditions for the second-pass printing for the engine 6 (step S10). In the second-pass printing, since print processing is conducted for paper 8 already printed on one face, processing must be conducted with operating conditions different from those for the first-pass printing. Therefore, transfer voltage and the like differing from the first-pass printing is specified.

Processing for the relevant manual double-sided printing print job then differs according to whether or not the user instruction to execute second-pass printing is received (step S11). Since the user instruction is not received immediately after the first pass processing is completed, in such cases (NO in step S11), the CPU 52 first waits for completion of the print processing for the first pass page and discharge of that page (step S12). In other words, the CPU 52 waits for completion of all printing for the first-pass printing, and discharge all paper 8 printed with the manual double-sided printing to the paper discharge tray 62. In the example of manual double-sided printing of four pages, the CPU 52 moves processing to S12 with the first page being the initial page of the second-pass printing, and waits for discharge of the fourth page and second page being the first-pass printing.

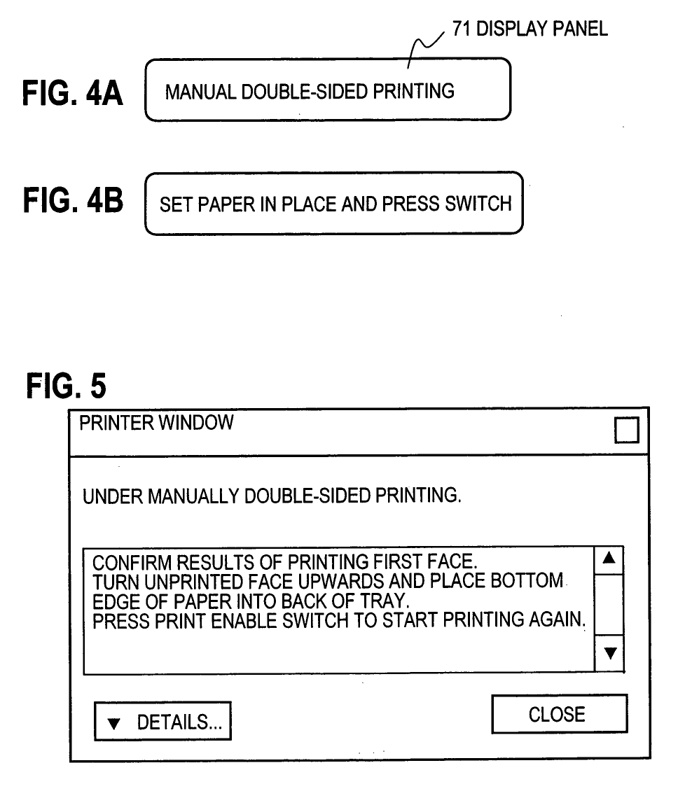

When discharge of paper in the first-pass printing is complete, the CPU 52 instructs the operation unit 7 to display a message reminding the user to set the paper 8 for the second-pass printing in place and issue the instruction to execute the second-pass printing (step S13). FIG. 4 shows an example of messages displayed on the operation unit 7 with this instruction. In the example in FIG. 4A, ‘Manual double-sided printing’ is displayed on the display panel 71 of the operation unit 7. The user checks again that manual double-sided printing is being conducted, and knows that it is the time at which the user places paper 8 for the second-pass printing in the MP tray 61, and presses the print enable switch 75 according to the procedure in the printer 2 operating manual and the like. In the example in FIG. 4B, since ‘Set paper in place and press switch’ is displayed on the display panel 71, the user knows that it is the time at which the user places the paper 8 for the second-pass printing in the MP tray 61, and presses the print enable switch 75 in accordance with the message.

Furthermore, the message displayed in this step S13 may also be sent to the host computer 1. In other words, an instruction is issued to display the message on the display apparatus (not shown in figures) of the host computer 1. FIG. 5 shows an example of a message displayed at the host computer 1. Since a large display area is normally possible at the host computer 1, as shown in FIG. 5, a more detailed message can be displayed than can be displayed on the operation unit 7. The user at the host computer 1 is reminded by the message to set the paper 8 for the second-pass printing in place, and press the print enable switch 75. The message (step S13) may be displayed on both the operation unit 7 and the host computer 1.

When the message is displayed in this manner, the user places the paper 8 printed in the first-pass printing and discharged to the paper discharge tray 62 in the MP tray 61 in the prescribed orientation, and presses the print enable switch 75 of the operation unit 7, in accordance with the message. In other words, the user issues an instruction to the effect that second-pass printing may be conducted. In the example of manual double-sided printing of four pages, the two sheets of paper 8 on which the fourth page and second page have been printed are taken from the paper discharge tray 62 and placed in the MP tray 61.

Thus, when the print enable switch 75 is pressed by the user, in other words, when the second-pass printing instruction is issued, the CPU 52 receives that user instruction (step S14) and issues an instruction to the engine 6 to supply paper for the relevant page (step S5). As with the first-pass printing, transfer of image data of the relevant page then begins (step S6). Since the MP tray 61 as the paper supply tray is specified (step S8), the engine 6 receiving the image data conducts print processing for the paper 8 placed in the MP tray 61, and discharges the printed paper to the paper discharge tray 62. Processing for the relevant page is completed by discharge of the paper (step S7). In the example of manual double-sided printing of four pages, processing for the first page being the initial page of the second-pass printing is then complete.

On the other hand, when the second-pass printing instruction already issued by the user for the relevant print job is received in step S11 (YES in step S11), processing moves to step S5, and a sequence of processing from issuing the paper supply instruction (step S5) to print processing and discharge of the paper (step S7) is conducted. In other words, print processing is conducted without display of a message for the user. In the example of manual double-sided printing of four pages, this processing is conducted for the third page, and the four-page print job is completed.

As described above, in the printer 2 according to the present embodiment, when manually double-sided printing, a message reminding the user to issue a second-pass printing instruction is displayed after discharge of the paper for the first-pass printing. The user then responds to that message by issuing the second-pass printing instruction, and printing for the second-pass printing begins after this instruction. Therefore, when the message reminding the user to issue the second pass print instruction is seen, the paper 8 to be set in place for the second-pass printing is already in the paper discharge tray 62, and the user can naturally, and without mistake, set the paper 8 appropriately in the MP tray 61, and press the print enable switch 75 in accordance with the message. Since the printer 2 conducts second-pass printing after this user operation (issuing of instructions), print processing is conducted reliably for the paper 8 set in place by the user, and there is almost no danger of printing on another sheet of paper by mistake in the second-pass printing. Thus, in the printer 2, the processing for the second-pass printing associated with user operation can be conducted more reliably, when manually double-sided printing.

The printer 2 of the present embodiment is a four-cycle laser printer, however printers known as tandem printers and monochrome printers may also be used. Furthermore, other types of printers such as ink-jet printers and the like may also be used. Furthermore, while the present embodiment is a host-based system, the present invention can be applied to systems other than host-based systems. Furthermore, the present invention is not limited to printers, and can also be applied to image forming apparatuses such as copiers and the like.

The scope of protection of the present invention is not limited to the afore-mentioned embodiments, and extends to the scope disclosed in the claims, and to equivalent objects.

What is claimed is:

1. An image forming apparatus for executing manual double-sided printing in which paper is supplied by a user when printing on the rear face of paper after printing on the front face of the paper is completed, comprising:
a display unit which displays a message reminding the user to issue an instruction to perform printing on the rear face after completing printing on the front face of the paper and discharging the paper;
a control unit which issues a paper supply instruction according to the instruction from the user to perform printing on the rear face; and
a printing unit which supplies paper from a prescribed paper supply unit according to the paper supply instruction and executing printing on the rear face.

2. The image forming apparatus according to claim 1, wherein the display unit displays a message to remind the user to set the paper in the paper supply unit when displaying the message to remind the user to issue the instruction to perform printing on the rear face.
